(19) United States
(12) Patent Application Publication
(10) Pub. No.: US 2003/0032556 A1
(43) Pub. Date: Feb. 13, 2003

(54) Filtering component in the form of activated carbon fibres

(76) Inventor: Ludovic Ouvry, Lyon (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/239,130

(22) PCT Filed: Mar. 21, 2001
(86) PCT No.: PCT/FR01/00835

(51) Int. Cl. C01B 31/08

(52) U.S. Cl. 502/418

(57) ABSTRACT

The method comprises the steps consisting in making a preform of the piece to be manufactured out of a coherent fabric of carbon precursor fibers, by using a manufacturing process such as knitting, stitching the two-dimensional fabric, or braiding; and performing carbonization and activation treatment to obtain directly the desired shaped piece made of activated carbon fibers; the preform being dimensioned so as to take account of shrinkage during the carbonization and activation treatment. The method can be used in particular for making pieces of clothing to provide protection against attack such as nuclear, biological, or chemical attack.

### FIELD OF THE INVENTION

The invention relates to manufacturing shaped filter pieces having adsorbent properties by using activated carbon fibers. The term “shaped filter pieces” is used herein to mean self-supporting filter pieces of non-planar shape.

The invention relates specifically to making shaped pieces of clothing, e.g. gloves, socks, under-garments, caps, . . . for use by civilian or military personnel to protect them against aggression, in particular of nuclear, biological, or chemical origin.

Nevertheless, the method of the invention can be used in other applications, for example to make filter pieces having special shapes, such as sleeves, spherical caps, or the like.

### BACKGROUND OF THE INVENTION

Various materials have been proposed for making nuclear, biological, chemical (NBC) protective garments.

Thus, it is known to make protective suits out of thick rubber, typically isobutyl rubber. Such suits are particularly uncomfortable and difficult to bear when the temperature is relatively high since they retain respiration.

Proposals have also been made to use particles of active charcoal dispersed in a foam, e.g. a polyurethane foam. Suits or garments made in this way are thick. They also present the drawbacks of being difficult to wash and of behaving poorly in the presence of fire, because of the presence of the foam. In addition, if they need to be laminated on a shaped substrate in order to be used, then porosity and breatheability can be affected. In addition, under moist conditions, e.g. because of sweating, the adsorption ability of active charcoal is diminished.

Proposals have also been made to use activated carbon fibers. Their mechanical properties make it difficult to subject them to textile operations such as spinning, weaving, knitting, sewing, braiding, . . . in order to make shaped pieces of clothing. It might be thought that activated carbon fibers could be assembled onto a substrate having the shape of the garment to be made, but that returns to the drawbacks mentioned above concerning pores becoming obstructed and a reduction in breatheability.

In order to solve the problem posed by carbon fibers being unsuitable for textile operations, document FR 2 599 761 A proposes using a composite thread comprising a core having the required mechanical properties, for example a metal core, with carbon precursor fibers being wound or lapped thereon. The composite thread can be used for making a cloth prior to carbonizing the carbon precursor fibers and activating them. According to document FR 2 599 761 A, the resulting cloth can be used for making protective pieces of clothing. A drawback of that method lies in the complexity and the cost involved in making the composite thread. Another drawback lies in the presence of metal reinforcement in the resulting pieces of clothing which makes them very stiff, and that can be penalizing from the discretion point of view for military applications.

Activated carbon cloth is known and used for filter piece applications. Document FR 2 741 363 A and WO 989/41678 A describe the making of such cloth. Nevertheless, making shaped pieces of clothing from that cloth requires a sewing operation. Unfortunately, stitches made in activated carbon cloth give rise to a significant local increase in stiffness, giving rise to discomfort. In addition, by leading to pores of non-uniform size, stitches provide easy passages for the toxins that ought to be retained.

### OBJECTS AND SUMMARY OF THE INVENTION

An object of the present invention is to provide a method enabling shaped filter pieces to be made, and particularly but not exclusively pieces of clothing for NBC protection, but without encountering the above-specified drawbacks.

More particularly, the invention seeks to obtain such shaped filter pieces that are made integrally out of activated carbon fibers, that are washable, thermally stable, and capable of retaining good adsorption properties under moist conditions, while intrinsically presenting good mechanical strength and offering pores that are free from any preferred passages for the medium that is to be filtered.

These objects are achieved by a method comprising the steps consisting in:

using a textile manufacturing method to make a preform of the piece to be manufactured out of a coherent fabric of carbon precursor fibers; and

performing carbonization and activation treatment so as to obtain directly the desired shaped piece made of activated carbon fibers;

the preform being dimensioned so as to take account of shrinkage during the carbonization and activation treatment.

The invention is remarkable in that the filter piece is obtained directly after carbonizing and activating a preform of carbon precursor fibers that have previously been worked using a textile method to give a shape corresponding to that of the piece that is to be made.

The textile method used for shaping the preform can be constituted, at least in part, by knitting, sewing a two-dimensional fabric, or braiding. The term “two-dimensional fabric” is used herein to mean in particular a woven cloth or a multidirectional web.

The preform is made in particular as a cellulose fiber fabric, e.g. using rayon fibers, thus making it possible to obtain carbon fibers of high purity and to obtain a large specific surface area, for example greater than 800 square meters per gram (m²/g), or indeed greater than 1200 m²/g.

In a first implementation of the method, the carbonization and activation treatment comprises:

a carbonizing step comprising heat treatment under an inert atmosphere up to a temperature lying in the range 250° C. to 500° C.; and

a step of activating the carbonized preform performed at a temperature lying in the range 750° C. to 950° C.

Activation is performed under an oxidizing atmosphere such as water vapor and/or carbon dioxide.

In a second implementation of the method, the carbonization and activation sequence comprises:

a step of impregnating the preform with a composition containing at least one ingredient having a function of promoting cellulose decomposition; and

heat treatment at a temperature lying in the range 350° C. to 500° C. so that a filter piece of activated carbon fibers is obtained directly.

The invention also provides a piece of clothing of the kind that can be obtained by the method, i.e. a shaped piece of clothing characterized in that it is made as a single piece of coherent fabric constituted by activated carbon fibers.

Such a piece of clothing is remarkable in that it intrinsically presents the strength needed to enable it to be used, while nevertheless being made of activated carbon fibers.

In addition, since they are made of carbon, pieces of clothing of the invention present good characteristics in the presence of fire and they are thermally stable. Because of their conductivity, carbon fibers enable static electricity to be evacuated. They are also easily washable. Compared with particles of active charcoal, pieces made of activated carbon fibers present very limited loss of performance due to moisture. The vast majority of the pores in activated carbon fibers are micropores that are not suitable for becoming filled with water by capillarity. In addition, because they are much smaller in size than particles of active charcoal, activated carbon fibers present a much greater outside surface area to a flow of gas for a given weight of carbon. For given performance, the thickness of the pieces concerned can be greatly reduced.

### BRIEF DESCRIPTION OF THE DRAWINGS

The invention will be better understood on reading the following description given by way of non-limiting indication and with reference to the accompanying drawing, in which:

FIG. 1 shows the successive steps in a method constituting an implementation of the invention;

FIG. 2 shows the successive steps in a method constituting a variant of the FIG. 1 implementation; and

FIG. 3 is a photograph showing a preform for a glove knitted using a viscose thread, and the activated carbon fiber glove obtained after applying carbonization and activated treatment to the preform.

### DETAILED DESCRIPTION OF EMBODIMENTS

In the description below, reference is made to manufacturing protective pieces of clothing. As mentioned above, the invention is nevertheless not limited to this application and it covers, more generally, making shaped filter pieces.

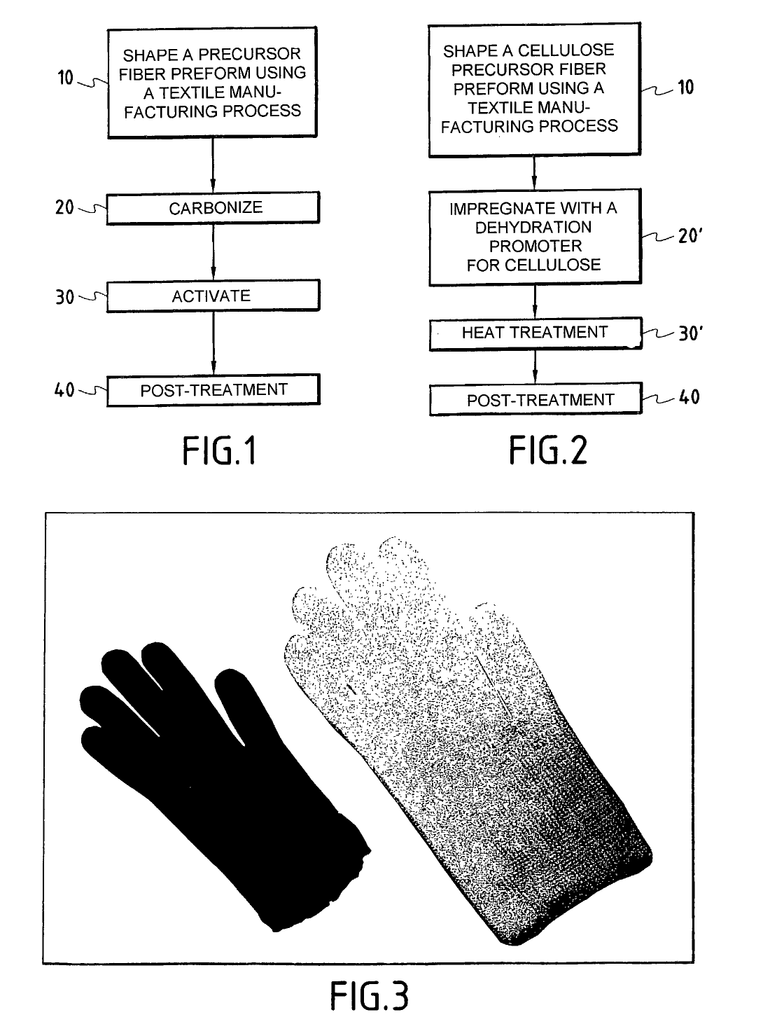

A first step 10 of the method shown in FIG. 1 consists in making a preform of the piece to be made, using a textile manufacturing process.

The preform is made using carbon precursor fibers which are in the form of thread or yarn. Various types of precursor can be used such as preoxidized polyacrylonitrile (PAN), pitch, phenol compounds. Preferably a cellulose precursor is used, in particular a viscose, e.g. rayon.

The preform is shaped to have a shape corresponding to that of the piece that is to be made, while nevertheless allowing for shrinkage that occurs during carbonization and activation treatment.

The shaping can be implemented directly using the threads or yarns of carbon precursor fiber, in particular by knitting or braiding.

It is also possible to begin by making a two-dimensional fabric from the carbon precursor fiber threads or yarns, e.g. a woven cloth or a multidirectional web, with the preform then being shaped by being cut and stitched using a thread of the same kind. A multidirectional web is formed by superposing a plurality of unidirectional webs made up of threads or yarns extending parallel to a given direction. The unidirectional webs are superposed to extend in different directions and they are optionally bonded to one another, e.g. by stitching or by light needling.

A second step 20 of the method consists in carbonizing the preform. Carbonizing comprises a stage of heat treatment in an inert atmosphere at a temperature lying in the range 250° C. to 500° C., for example a temperature equal to about 400° C., this stage being performed with a slow rise in temperature, typically at a rate of 0.01° C. per minute (min) to 0.5° C./min over a relatively long duration of several days to several weeks.

A final stage of heat treatment can subsequently be performed at a higher temperature, e.g. up to 600° C. to 900° C., likewise under an inert atmosphere, for a duration that is much shorter, for example a few minutes.

Additional heat treatment at a temperature that is even higher, e.g. lying in the range 1000° C. to 1300° C. and under reduced pressure, e.g. pressure lying in the range 5 Pascals (Pa) to 60 Pa may optionally be performed for a relatively short duration, about 1 minute, in order to encourage elimination of impurities that are entrained with the gaseous effluent.

A third step 30 of the method consists in activating the resulting carbon fiber preform. Activation is performed by subjecting the carbon fiber preform to heat treatment under an oxidizing atmosphere such as water vapor or preferably carbon dioxide or a mixture of carbon dioxide and water vapor. Reference can be made to above-cited document FR 2 741 363 A. The heat treatment temperature lies in the range 750° C. to 950° C., and preferably in the range 850° C. to 950° C., and its duration preferably lies in the range 50 min to 300 min as a function of the desired specific surface area. It is thus possible to obtain an activated carbon fiber piece presenting a specific surface area greater than 800 m²/g, or even greater than 1200 m²/g.

A final step 40 of post-treatment may optionally be performed, as a function of the intended use for the piece. By way of example, one kind of post-treatment may consist in forming a very fine deposit so as to fix any particles of carbon and prevent them coming off when the piece is in use. This deposition can be performed by spraying elastomer or latex.

Another type of post-treatment may consist in associating the piece with a lining whose function is not to give strength to the piece but to avoid direct contact between the piece and the skin of the user. The lining may be aerated so as to avoid affecting porosity and permeability and it need be connected to the piece via a few points only, e.g. by adhesive.

FIG. 2 shows a variant implementation of the method suitable for use with a preform of cellulose precursor fibers. This variant differs from the method of FIG. 1 in that steps 20 and 30 of carbonization and of activation are replaced by a step 20′ of impregnating the preform with a composition containing an ingredient that promotes dehydration of cellulose, and a heat treatment step 30′ that serves to obtain the piece made of activated carbon fibers directly.

Impregnation is performed using a composition containing at least one ingredient that promotes dehydration of cellulose, such as an inorganic ingredient selected from phosphoric acid, zinc chloride, potassium sulfate, potassium hydroxide, diammmonia phosphate, and ammonium chloride. Impregnation is preferably performed using a composition containing phosphoric acid so that the mass of acid fixed on the preform lies in the range 10% to 22% by weight of the dry preform. The heat treatment comprises raising temperature at a rate lying in the range 1° C./min to 15° C./min followed by a pause which is preferably performed at a temperature lying in the range 350° C. to 500° C. under an inert atmosphere or under an atmosphere containing a reaction activator such as carbon dioxide or water vapor. The resulting piece is preferably subsequently washed. Such a method is described in above-mentioned international patent application WO 98/41678. A piece made of activated carbon fibers is thus obtained directly.

### EXAMPLE 1

Glove preforms of the kind shown on the left in the photograph of FIG. 3 were made by knitting a 330 decitex (dtex) rayon thread with stocking stitch, the edging of the gloves being made using a 167 dtex rayon thread.

The preforms were placed on frames in a kiln and subjected to heat treatment for about 2 weeks. Temperature was raised very slowly, less than 0.1° C./min, until a level of about 400° C. was reached.

The resulting preforms were subsequently subjected again to heat treatment up to a temperature of about 700° C. for a period of about 15 min so as to stabilize the carbon lattice.

The carbonized preforms were activated in a rotary autoclave at a temperature of about 850° C. under an atmosphere of carbon dioxide (CO₂) for a period of about 1 hour (h).

The resulting gloves were like the gloves shown in the photograph of FIG. 3 (on the right). They presented the following mean characteristics:

specific surface area approximately equal to 1500 m²/g;

breaking strength in traction equal to about 1.5 decanewtons per centimeter (daN/cm);

breaking elongation: about 50%;

carbon content: about 95%;

diameter of the activated carbon fibers (filaments): about 17 micrometers (μm).

The shrinkage caused by carbonization and activation was on average 32%. This shrinkage needs to be taken into account in order to make preforms that give rise to gloves of the desired sizes.

It should be observed that depending on the textile manufacturing process used and the shapes of the pieces, shrinkage is not necessarily uniform throughout a piece and in all directions. The shape to be given to the preform is preferably determined by testing, which tests can enable simulation models to be devised.

In order to avoid direct contact with the skin, the activated fiber carbon glove can be put on over an underglove, e.g. of cotton. The underglove and the glove can be connected together by means of a few spots of adhesive.

The resulting assembly is directly insertable in an overglove, e.g. made of leather. In operation, only the subassembly formed by the activated carbon fiber glove and any underglove is consumable. It is also easy to incinerate without giving off toxic effluent.

### EXAMPLE 2

Glove preforms such as those of Example 1 were impregnated by being immersed in a 20% by volume solution of phosphoric acid H₃PO₄ in water. The impregnated preforms were baked at a temperature lying in the range 70° C. to 90° C. to drive off the water, and the quantity of phosphoric acid fixed on the preforms constituted about 16% by weight relative to the weight of the dried preforms.

The preforms were then inserted continuously into a heat treatment oven through which they traveled while supported on a belt, e.g. made of glass fibers. The heat treatment comprised a rise in temperature at a rate of about 5° C./min, followed by a level temperature of about 200° C. The heat treatment was performed under an inert atmosphere (nitrogen) for a total duration of about 90 min.

The resulting gloves were washed in demineralized water at a temperature of about 90° C.

The activated carbon fiber gloves made in this way presented the following characteristics:

specific surface area approximately equal to 800 m²/g;

traction breaking strength equal to about 1.2 daN/cm;

breaking elongation about 50%;

carbon content about 80%.

The measured shrinkage on average was 28%.

### TESTS

Tests of effectiveness against mustard gas were performed using the gloves obtained in Example 1.

A vapor phase test was performed with mustard gas at 37° C.

No passage through the protective barrier constituted by the glove was observed after more than 8 h.

A liquid phase test was performed using mustard gas at ambient temperature (20° C.). The mustard gas was put into contact with the gloves in the form of drops, with the quantity of contamination used representing 10 g/m² of the surface of the gloves. The quantity of mustard gas that pass through the gloves was measured by extracting a flow of air at a speed of 0.2×10⁻² meters per second (m/s) from the inside of the gloves. After 24 h, the measured quantity that had penetrated lay in the range 0.2 micrograms per square meter (μg/m²) to 1.02 μg/m².

These tests show the remarkably effective protection obtained due to the adsorption properties of activated carbon fibers.

1/ A method of manufacturing a shaped filter piece comprising activated carbon fibers, the method being characterized in that it comprises the steps consisting in:
using a textile manufacturing method to make a preform of the piece to be manufactured out of a coherent fabric of carbon precursor fibers; and
performing carbonization and activation treatment so as to obtain directly the desired shaped piece made of activated carbon fibers;
the preform being dimensioned so as to take account of shrinkage during the carbonization and activation treatment.

2/ A method according to claim 1, characterized in that the preform is made at least in part by knitting threads made of carbon precursor fibers.

3/ A method according to claim 1, characterized in that the preform is made at least in part by stitching a two-dimensional fabric of carbon precursor fibers.

4/ A method according to claim 1, characterized in that the preform is made at least in part by braiding threads made of carbon precursor fibers.

5/ A method according to any one of claims 1 to 4, characterized in that the preform is made of a coherent cellulose fiber fabric.

6/ A method according to claim 5, characterized in that the preform is made of a coherent rayon fiber fabric.

7/ A method according to any one of claims 1 to 6, characterized in that the carbonization and activation treatment comprises:
a carbonizing step comprising heat treatment under an inert atmosphere up to a temperature lying in the range 250° C. to 500° C.; and
a step of activating the carbonized preform performed at a temperature lying in the range 750° C. to 950° C.

8/ A method according to either one of claims 5 and 6, characterized in that the carbonization and activation treatment comprises:
a step of impregnating the preform with a composition containing at least one ingredient having a function of promoting cellulose decomposition; and
heat treatment at a temperature lying in the range 350° C. to 500° C. so that a filter piece of activated carbon fibers is obtained directly.

9/ A shaped piece of protective clothing comprising activated carbon fibers, the piece being characterized in that it is made as a single piece of coherent fabric made up of activated carbon fibers.

10/ A piece of clothing according to claim 9, characterized in that it is constituted at least in part by a knit of threads constituted by activated carbon fibers.

11/ A piece of clothing according to claim 9, characterized in that it is constituted at least in part by a two-dimensional fabric of carbon fibers shaped by stitching.

12/ A piece of clothing according to claim 9, characterized in that it is constituted at least in part by a braid of threads constituted by activated carbon fibers.
